(19) United States
(12) Patent Application Publication
(10) Pub. No.: US 2016/0145901 A1
(43) Pub. Date: May 26, 2016

(54) LOW POWER OVERRIDE FOR LOCKING DEVICE

(71) Applicant: MUL-T-LOCK TECHNOLOGIES LTD., Yavne (IL)

(72) Inventor: Yair Levy, Almagor (IL)

(21) Appl. No.: 14/904,102

(22) PCT Filed: Jul. 8, 2014
(86) PCT No.: PCT/US14/45636

§ 371 Date: Jan. 10, 2016

(30) Foreign Application Priority Data
Jul. 11, 2013 (IL) 227456
Jul. 11, 2013 (IL) 227457

(51) Int. Cl. E05B 47/00; E05B 17/10; E05B 41/00; E05B 17/00; E05B 47/02; E05B 43/00

(52) U.S. Cl. CPC E05B 47/0001; E05B 47/02; E05B 43/005; E05B 41/00; E05B 17/0079; E05B 17/10; E05B 2047/0048; E05B 2047/0097; E05B 2047/0058; E05B 2047/0065; E05B 2047/0054; E05B 2047/0073

(57) ABSTRACT

A method is described for operating a locking device, including overriding normal operation of the locking device which is powered by a battery. If a charge of the battery gets lowered to a low battery charge threshold, the locking device goes into a hibernating mode, and the locking device is capable of being awakened for a limited time by a user operation.

### FIELD OF THE INVENTION

The present invention generally relates to locking devices, such as electromechanical locks, and more specifically to overriding normal operation of the locking device when there is a low power condition, as well as to a human-machine interface for use with the locking device that uses sensing technology, such as capacitive sensing technology.

### BACKGROUND OF THE INVENTION

There are many electrical locking devices, such as but not limited to, electromechanical locks, which are operated by battery power. As long as the battery is sufficiently charged, the battery provides sufficient power to retract one or more locking bolts to open the lock. When an electrical locking device battery runs too low (i.e., is insufficiently charged), it is no longer possible to operate the device and an authenticated operator might find himself locked out.

A common solution to this problem in the prior art is to power the device from an external power source (usually a 9V battery) through connectors that are placed on the outside of the device and allow the operator to provide an identifying authentication and unlock the device.

### SUMMARY OF THE INVENTION

The present invention seeks to provide novel methods and apparatus for overriding normal operation of the locking device when there is a low power condition, as is described more in detail hereinbelow.

The problem in the art is how to prevent a situation wherein the locking device stops working when the battery level drops below a certain operating level. The prior art makes the locking device operable once again by connecting an external battery or other current source to the external side of the locking device.

The present invention presents a different solution. Unlike the prior art, in the present invention, the locking device will not operate until the battery runs out. Instead a low battery charge threshold is defined; if the battery charge gets lowered to this threshold, the locking device stops consuming energy (or uses very little power) and goes into hibernating (“deep sleep”) mode. The locking device can be “awakened” for a limited time by a manual operation of the user. The invention provides a reminder for the user to charge or replace the battery, while at the same time ensuring the user is never locked out.

There is thus provided in accordance with a non-limiting embodiment of the present invention a system including a locking device that has locked and unlocked positions, a battery for powering operation of the locking device, and a processor for controlling operation of the locking device, wherein the processor has a mode of operation based on a low battery charge threshold, wherein if a charge of the battery gets lowered to the threshold, the locking device goes into a hibernating mode, and the locking device is capable of being awakened for a limited time by a manual operation.

In accordance with an embodiment of the present invention an external wakeup switch connected to internal wakeup circuitry for awakening the locking device from the hibernating mode.

There is also provided in accordance with an embodiment of the present invention a method for operating a locking device including overriding normal operation of the locking device, which is powered by a battery, wherein if a charge of the battery gets lowered to a low battery charge threshold, the locking device goes into a hibernating mode, and the locking device is capable of being awakened for a limited time by a user operation, e.g., a manual operation.

In accordance with an embodiment of the present invention if the charge of the battery gets lowered to a first low battery charge threshold, the locking device is capable of being unlocked, but a warning is provided of reaching the first low battery charge threshold.

In accordance with an embodiment of the present invention if the charge of the battery gets lowered to a second low battery charge threshold, the locking device is capable of being unlocked only after a time delay.

In accordance with an embodiment of the present invention, upon reaching the second low battery charge threshold or a third threshold, operation of the electrical locking device is not possible.

In accordance with an embodiment of the present invention if the charge of the battery gets lowered to a third low battery charge threshold, the electrical locking device goes into the hibernating mode.

### BRIEF DESCRIPTION OF THE DRAWINGS

The present invention will be understood and appreciated more fully from the following detailed description, taken in conjunction with the drawings in which:

FIG. 1 is a simplified illustration of a system for controlling operation of a locking device, in accordance with an embodiment of the present invention;

FIG. 2 is a simplified block diagram of a method for controlling operation of a locking device, in accordance with an embodiment of the present invention;

FIG. 3 is a simplified pictorial illustration of a human-machine interface for use with the locking device, in accordance with an embodiment of the present invention;

FIGS. 4A and 4B are simplified pictorial illustrations of a user sliding fingers on the human-machine interface in order to enter a command to the locking device, in accordance with an embodiment of the present invention; and

FIG. 5 is a simplified block diagram of a method for using the human-machine interface, in accordance with an embodiment of the present invention.

### DETAILED DESCRIPTION OF EMBODIMENTS

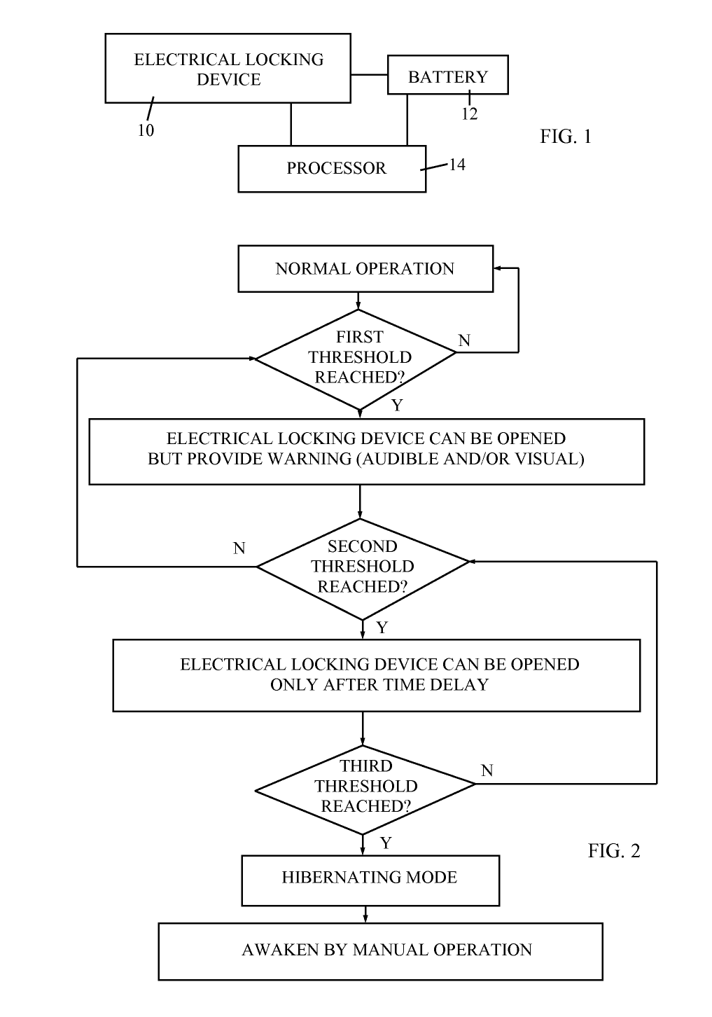

Reference is now made to FIG. 1, which illustrates a system for controlling operation of a locking device 10, in accordance with a non-limiting embodiment of the present invention.

Locking device 10 has locked and unlocked positions, as is well known in the art. A battery 12 powers operation of locking device 10. A processor 14 controls operation of locking device 10. Processor 14 has a mode of operation based on a low battery charge threshold, wherein if a charge of battery 12 gets lowered to the threshold, locking device 10 stops consuming energy or uses little power and goes into a hibernating mode. Locking device 10 is capable of being awakened for a limited time by a user operation, such as a manual operation. When awakened, locking device 10 may be in normal operation or optionally in some special operational mode, such as being operable only by certain persons with an authorization code.

Reference is now made to FIG. 2. A low battery charge threshold is defined (as will be seen below, more than one low threshold can be defined), wherein if the battery charge goes down to this threshold, the locking device stops consuming energy (or uses little power) and goes into hibernating mode. More specifically, this means the MCU (microcontroller unit) and RF (radiofrequency) devices or any other electrical devices of the locking device go into hibernating mode. The locking device can be awakened for a limited time by a manual operation of the user or any other user operation. For example, an external wakeup switch (e.g., a pin) may be provided in the device, such as on an external side of the lock, which can be pushed by a small implement (e.g., pen or pencil point). The external wakeup switch is connected to internal wakeup circuitry. Other wakeup switches and devices may be used, such as but not limited to, a reed switch, pushable mechanical switch, optical switch, spring and others.

The sleep mode of the invention provides longer operation times even if the locking device is left unused for a long period.

The following are non-limiting examples of low battery charge thresholds (also referred to as low battery warnings):

Below ˜200 operations remaining: The locking device can be opened (i.e., unlocked), but an audio warning is sounded when the locking device is opened that a (first) low battery charge threshold has been reached. Additionally or alternatively, a visual warning may be displayed, such as on a fingerprint display of the device (for inputting an identifying fingerprint) or on a touch screen of the locking device display.

Below ˜50 operations remaining: The locking device can be opened (i.e., unlocked), but only after a short time delay (e.g., 1-10 seconds delay, or more preferably 3 seconds). In one embodiment, opening is restricted to action of manual operation buttons and RF actuation of the lock is not possible.

Below ˜25 operations remaining: The locking device stops responding to the operating buttons (e.g., manual and RF) and enters hibernating mode (deep sleep), until awakened as described above. The locking device may hibernate after a time delay, such as but not limited to, 60 seconds. The locking device responds to an OPEN command, but does not automatically lock. In other words, the user is never locked out.

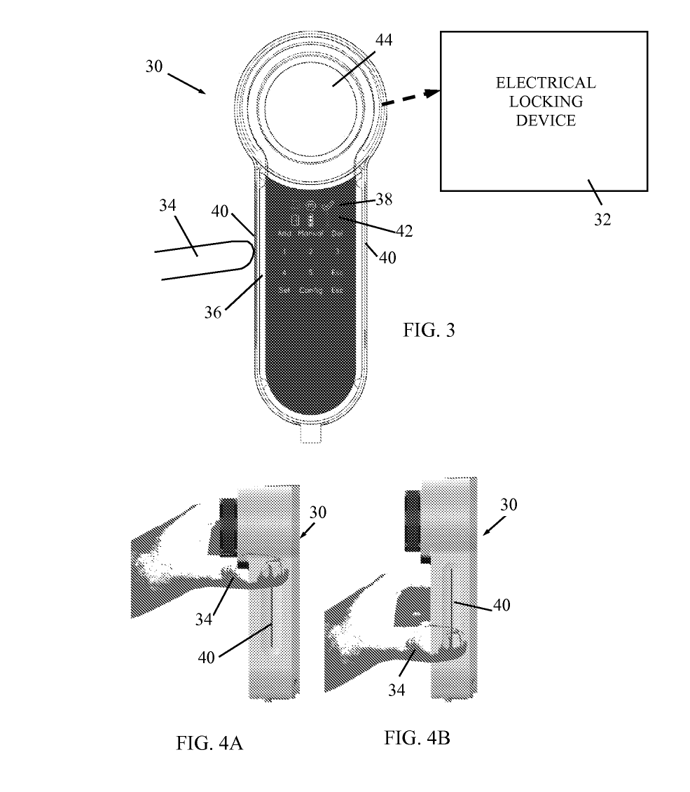

Reference is now made to FIG. 3, which illustrates a human-machine interface 30 for use with a mechanical or electromechanical locking device 32, in accordance with a non-limiting embodiment of the present invention. FIGS. 4A and 4B illustrate a user employing interface 30.

The human-machine interface 30 makes use of sensing technology, such as but not limited to, capacitive sensing technology, which measures the changing capacity between a human finger 34 and capacitive sensing circuitry 36, preferably embodied in a PCB (printed circuit board). The interface 30 has one or more interface surfaces 38, for sensing movements of the finger 34, such as but not limited to, a touch screen 38 on the face of the interface 30 (or any other suitable surface for capacitive sensing technology), and surfaces 40 on the left and right sides of the interface 30. The movements of the finger 34 (such as, but not limited to, gliding, tapping, swiping, long press, short press, etc.) on these surfaces are sensed by capacitive sensing circuitry 36, which sends a command signal, such as but not limited to, a lock operating signal, a programming signal and others, to electrical locking device 32 based on the sensed finger movements (such as to unlock or lock the device 32, for example).

It is noted that the capacitive sensing circuitry 36 can be sufficiently sensitive such that the user's fingers do not need to glide on the interface surfaces 38; instead the fingers can be moved in the air close to interface surfaces 38 so that the air serves as a dielectric and the capacitance circuitry senses the finger movement. Other technologies can be used to carry out the invention other than capacitive sensing technology, such as but not limited to, optical sensors (cameras), infrared heat sensors and others. All these sensors and sensing surfaces are referred herein by the terms finger-movement sensors and finger-movement sensing surfaces.

The capacitive sensing surfaces 38 and 40 can be enhanced with one or more illuminating indications 42 (e.g., LED indications), that illuminate the way the finger slides (or otherwise moves) and track the direction of motion. This enhances the user experience and makes the interface user friendly. The use of multiple sensing surfaces provides a user friendly, intuitive and aesthetic interface and a very flexible platform for software options, while taking up minimal space as compared to normal buttons or keypads.

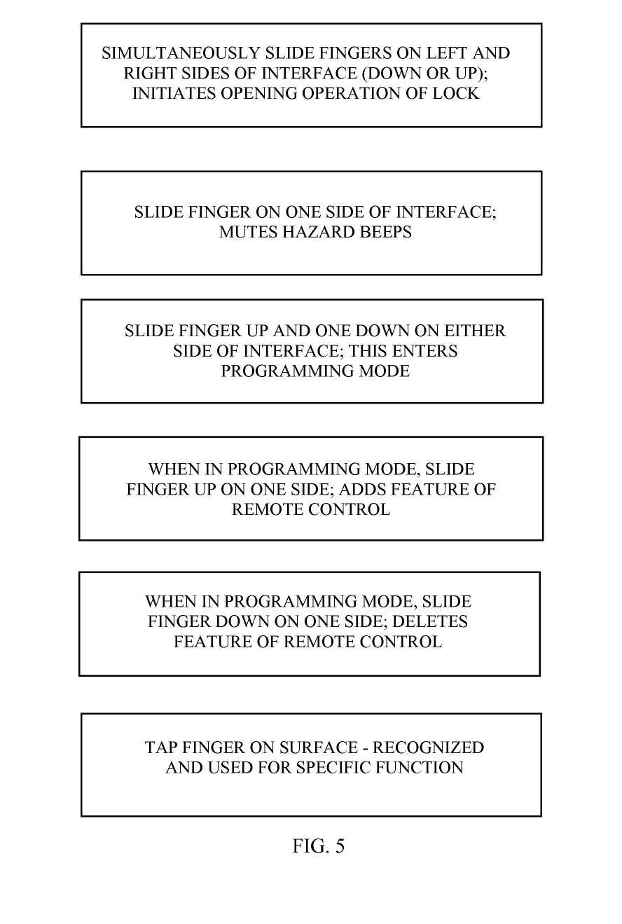

Here are some non-limiting examples of possible functions in accordance with embodiments of the invention (FIG. 5):

a. Simultaneously sliding fingers on the left and right sides of the interface 30 (down or up); this initiates an opening operation of the lock.

b. Sliding a finger on one side of the interface 30 (e.g., up then down); this mutes hazard beeps.

c. Sliding one finger up and one down on either side of interface 30; this enters programming mode.

d. When in programming mode, sliding a finger up on one side (e.g., the right side); this adds the feature of remote control.

e. When in programming mode, sliding a finger down on one side (e.g., the left side); this deletes remote control.

f. Tapping a finger on the surface can be recognized and used for a specific function, such as indicating to a remote center that the lock has just been locked.

It is noted that use of the interface 30 may be limited when used by a gloved hand, such as in very cold environments. In accordance with an embodiment of the invention, interface 30 may additionally include a resistive touchscreen 44, which for certain applications (such as when the user has a glove on the hand) may be used in place of, or in addition to, capacitive sensing surfaces 38 and 40.

What is claimed is:

1. A system comprising:
a locking device that has locked and unlocked positions;
a battery for powering operation of said locking device; and
a processor for controlling operation of said locking device, wherein said processor has a mode of operation based on a low battery charge threshold, wherein if a charge of said battery gets lowered to said threshold, said locking device goes into a hibernating mode, and said locking device is capable of being awakened for a limited time by a user operation.

2. The system according to claim 1, comprising an external wakeup switch connected to internal wakeup circuitry for awakening said locking device from the hibernating mode.

3. A method for operating a locking device comprising:
overriding normal operation of the locking device, which is powered by a battery, wherein if a charge of said battery gets lowered to a low battery charge threshold, said locking device goes into a hibernating mode, and said locking device is capable of being awakened for a limited time by a user operation and providing an external wakeup switch connected to internal wakeup circuitry for awakening said locking device from the hibernating mode.

4. The method according to claim 3, wherein if the charge of said battery gets lowered to a first low battery charge threshold, said locking device is capable of being unlocked, but a warning is provided of reaching said first low battery charge threshold.

5. The method according to claim 4, wherein said warning is audible.

6. The method according to claim 4, wherein said warning is visual.

7. The method according to claim 4, wherein if the charge of said battery gets lowered to a second low battery charge threshold, said locking device is capable of being unlocked only after a time delay.

8. The method according to claim 7, wherein upon reaching said second low battery charge threshold or a third threshold, operation of said locking device is not possible.

9. The method according to claim 7, wherein if the charge of said battery gets lowered to a third low battery charge threshold, said locking device goes into the hibernating mode.

10. A method for operating a locking device comprising:
providing a human-machine interface that comprises one or more finger-movement sensing surfaces; and
using sensing circuitry to sense a movement of one or more fingers relative to said finger-movement surfaces, said sensing circuitry sending a command signal to a locking device based on the movement sensed.

11. The method according to claim 10, wherein said movement comprises simultaneously sliding fingers on left and right sides of said interface.

12. The method according to claim 10, wherein said movement comprises sliding a finger on one side of said interface.

13. The method according to claim 10, wherein said movement comprises sliding one finger up and one down on either side of said interface.

14. The method according to claim 10, wherein said movement of the one or more fingers comprises movement of at least two fingers simultaneously.

15. The method according to claim 10, wherein said movement of the one or more fingers comprises movement of at least two fingers one after the other.
